(19) United States
(12) Patent Application Publication
(10) Pub. No.: US 2025/0055863 A1
(43) Pub. Date: Feb. 13, 2025

(54) SYSTEM AND METHOD FOR LIGHTWEIGHT IOT BOTNET DETECTION BASED ON FLOW POINT CLUSTERING

(71) Applicant: SHANGHAI JIAO TONG UNIVERSITY, Shanghai (CN)

(72) Inventors: Futai ZOU, Shanghai (CN); Zhimo ZHOU, Shanghai (CN); Liang ZHANG, Shanghai (CN); Yue WU, Shanghai (CN)

(21) Appl. No.: 18/231,406

(22) Filed: Aug. 8, 2023

(51) Int. Cl. H04L 9/40; G16Y 30/10

(52) U.S. Cl. CPC H04L 63/1425; G16Y 30/10; H04L 2463/144

(57) ABSTRACT

The present disclosure provides a system for IoT Botnet detection, comprising: a flow preprocessing device for processing the flow data packets to obtain NetFlow data; a flow clustering device for segmenting the NetFlow data to obtain flow points, and clustering the flow points to form botnet transactions or normal behavior transactions; a fingerprint generation device for extracting feature fingerprints from the obtained transactions and converting the feature fingerprints into RGB fingerprint images; and a classification device for detecting the fingerprint images and yielding the classification results.

### TECHNICAL FIELD

The present disclosure belongs to the technical filed of information safety and relates to a system and a method for IoT Botnet detection.

### BACKGROUND

The Internet of Things (IoT) has become an integral part of our lives. With the advancement of IoT, communication capabilities are no longer limited to mobile devices but extend to all things that coexist with humans. The Global System for Mobile Communications Association (GSMA) predicts that by 2025, the global number of IoT devices (including cellular and non-cellular) will reach approximately 25.2 billion.

The exponential growth in the number of IoT de-vices also provides favorable conditions for IoT attacks. According to a report by Straits Research, global spending on IoT security reached 11.7 billion USD in 2022 and is expected to reach 122.3 billion USD by 2031.

According to the “Global Threat Landscape Re-port for the Second Half of 2022” released by Fortinet, a US network and cybersecurity company, there were over 270 million botnet activities in November 2022, which increased to 499 million in December, an 85% growth. Attackers often utilize botnets, which are networks of infected devices, to conduct various types of network attacks. These infected devices can include desktop computers, laptops, smartphones, or IoT devices. Botnets provide attackers with a large-scale platform for launching attacks. Once a significant number of devices are infected with the botnet malware, attackers can control each bot host within the botnet network, issue commands to them, and coordinate at-tacks. The range of these attacks varies from spreading spam emails to launching attacks on domain name servers to paralyze them, with varying degrees of severity.

In recent years, botnets remain one of the most destructive forms of attacks. On May 19, 2017, hackers initiated a global botnet attack targeting machines running Microsoft Windows operating system. Despite being blocked within days of its discovery, the attack still caused significant damage and disruptions, affecting over 300,000 computers in more than 150 countries worldwide. Therefore, researching and detecting botnet attacks hold great significance.

So far, many studies have proposed machine learning-based methods for detecting botnets. However, the outstanding performance of these methods is only applicable to specific datasets. Some researchers have also incorporated deep learning techniques. For example, Sriram et al. used deep neural networks to extract features from traffic and analyzed the entire payload data to detect botnets. However, this approach lacks interpretability and lacks detailed descriptions. Hussain et al. trained a ResNet-18 model to detect scanning attacks and DDoS attacks in botnets, achieving good detection results, but the detection scope is limited. Some researchers have attempted to use artificial neural networks and recurrent neural networks, but these methods have high computational complexity.

On the other hand, since botnets are a problem involving the entire Internet and spanning multiple administrative domains, a solution covering the scale of the Internet is required. However, real-time processing of such large-scale data poses significant challenges.

### SUMMARY

In view of the above defects of the prior art, the present application provides system for lightweight IoT Botnet detection based on flow point clustering, comprising:

a flow preprocessing device for processing the flow data packets to obtain NetFlow data;
a flow clustering device for segmenting the NetFlow data to obtain flow points, and
clustering the flow points to form botnet transactions or normal behavior transactions;
a fingerprint generation device for extracting feature fingerprints from the obtained transactions and converting the feature fingerprints into RGB fingerprint images; and
a classification device for detecting the fingerprint images and yielding the classification results.

The technical effects of the present disclosure includes the follows.

A lightweight IoT botnet detection system called FC-Bot is provided, based on flow point clustering. NetFlow has the advantage of being lightweight, making it easy to collect and organize data without accessing, reading, or recording any payload data carrying IoT content. This approach not only protects privacy but also proves to be more applicable in real scenarios with massive traffic.

FC-Bot introduces an innovative design of the flow clustering module. It first divides and segments flow data into flow points based on time, effectively addressing the issue of time unification. Then, the flow points are clustered to achieve collective behavior at the transaction level, distinguishing between normal transactions and IoT botnet transactions for the purpose of IoT botnet detection.

FC-Bot extracts transaction features to create fingerprint images, which are then classified using a convolutional neural network. Validation results on public datasets demonstrate an F1 score of 95.04% for FC-Bot, confirming its effectiveness in IoT botnet detection. Moreover, compared to state-of-the-art detection solutions, FC-Bot achieves the lowest false positive rate of only 3.06%. Additionally, in real-world open IoT environments, FC-Bot is capable of uncovering hidden botnets, achieving an F1 score of 92.59%, further validating its detection capabilities.

In the following contents, the concept, specific structure and technical effect of the present disclosure will be further described in combination with the drawings, so as to fully understand the purpose, features and effect of the disclosure.

### BRIEF DESCRIPTION OF THE DRAWINGS

FIG. 1 is a schematic diagram showing a frame of the system for lightweight IoT Botnet detection based on flow point clustering.

FIG. 2 is a schematic diagram showing a frame of the FC-Bot, which is divided into four components.

FIG. 3 is a schematic diagram showing examples of three fingerprint images in a preferred embodiment of the present disclosure.

FIG. 4 is a schematic diagram showing the F1 value of the test set corresponding to different Minszie in a preferred embodiment of the present disclosure.

FIG. 5 is a schematic diagram showing the results of the model under different N in a preferred embodiment of the present disclosure.

FIG. 6 is a schematic diagram showing FC-Bot training and validation accuracy when using optimal parameters in a preferred embodiment of the present disclosure.

FIG. 7 is a schematic diagram showing FC-Bot training and validation loss when using optimal parameters in a preferred embodiment of the present disclosure.

FIG. 8 is a schematic diagram showing comparison of experimental results between FC-Bot and advanced models in a preferred embodiment of the present disclosure.

### DETAILED DESCRIPTION OF THE PRERERRED EMBODIMENTS

Several preferred embodiments of the present disclosure are described with reference to the drawings of the specification, so that the present disclosure is clearer and easier to be understood. The present disclosure can be realized by many different forms of embodiments, and the protection scope of the present disclosure should not be limited to the embodiments mentioned herein.

In the drawings, the same components are represented by the same reference numbers, and the components with similar structure or function are represented by the similar reference numbers. The size and thickness of each component shown in the drawings are arbitrarily shown, and the present disclosure does not limit the size and thickness of each component. In order to make the drawings clearer, the thickness of the parts is appropriately exaggerated in some places in the drawings.

### Definition

### 1. NetFlow

NetFlow is a network protocol originally proposed and implemented by Cisco Systems. It is primarily used on network devices such as routers and switches. Its purpose is to capture network traffic and summarize it into sets of network flows, which are then forwarded to network flow collectors. NetFlow records inbound and outbound information of flows, including the start time, end time, packet count, and byte count of each flow. NetFlow records do not involve accessing, reading, or recording any payload data carrying packet contents. Therefore, they do not contain sensitive in-formation such as the specific content of requests and responses, such as file uploads and downloads, or the amount of interaction in IoT transactions. In other words, NetFlow records are content-agnostic, providing a certain level of privacy protection. Hence, when using NetFlow for IoT botnet detection, there is no need to have prior knowledge of the specific content of the packets.

### 2. IoT Botnet

The Internet of Things (IoT) can be defined as a network that enables communication between people and objects, as well as between objects themselves. With the widespread deployment of IoT devices, an increasing number of security vulnerabilities have been exposed, opening the doors to various types of attacks. Among them, IoT botnets have emerged as a fast-spreading and widely impactful form of attack. In the context of IoT, when a vulnerable device is compromised, it becomes a botnet host or “bot” and joins a large-scale botnet. Attackers can remotely access and control these botnet hosts through command and control servers, directing them to carry out malicious activities such as launching DDoS attacks or engaging in cryptocurrency mining. The massive scale of IoT bot-nets poses a significant threat to network security.

IoT devices possess processing capabilities, and some devices can perform tasks similar to simplified versions of professional computers. However, these devices often lack awareness of computer security, providing a fertile breeding ground for IoT botnets and other threats. The IoT has a massive number of devices, and device maintenance is insufficient, further enhancing the activity of IoT botnets beyond the impact range of traditional botnets.

### 3. HDBSCAN

HDBSCAN (Hierarchical Density Based Spatial Clustering of Applications with Noise, HDBSCAN) is a density-based clustering algorithm that is suitable for clustering tasks in application spaces with noise.

The HDBSCAN algorithm consists of five steps. First, it performs a spatial transformation based on density/sparsity to identify clusters with higher densities within sparse and noisy data. Second, it constructs a minimum spanning tree based on weighted distance, gradually merging the closest clusters to form a hierarchical tree-like structure. Then, it builds a hierarchical cluster structure among components, representing the results in the form of a tree diagram. Next, it applies compressed hierarchical clustering with a minimum cluster size, compressing the tree structure into a small-er tree while ensuring that each node contains more data points. Finally, it performs classification using the compressed generated tree.

The HDBSCAN algorithm is not limited by cluster shapes and densities, and it can achieve more robust clustering results with fewer hyperparameters. The introduced splitting measure in this algorithm provides a better reflection of the density characteristics of data points.

### 4. Kitsune

Kitsune is a packet-level anomaly detection system. It utilizes a packet capture module and a feature extraction module to extract 115-dimensional features from network packets passing through network nodes across five time spans. These features are then mapped to a low-dimensional representation and fed into an auto-encoder for processing. During the training phase, the autoencoder learns the representation of normal behavior in the subspace and raises alarms for anomalous data during the detection phase. In the following embodiments, the collected botnet packets are replayed and Kitsune is used to detect anomalous botnet traffic as baseline model.

### 5. Whisper

Whisper is a malicious traffic detection system based on frequency domain analysis. It encodes the packet feature sequence into vectors, segments them into frames, and applies discrete Fourier transform to each frame to extract the frequency domain sequence information of the traffic. During the training phase, Whisper employs the K-Means algorithm to compute the centroid of frequency domain features of benign traffic. In the detection phase, outliers are identified as malicious traffic. In the following embodiments, the collected botnet packets are replayed and Whisper is used to detect anomalous botnet traffic as baseline model.

### 6. 1DCNN

Kundu et al. proposed a botnet detection framework based on a 1D Convolutional Neural Net-work (1DCNN) model. The framework utilizes a feature extraction module to extract 199 features from network traffic and generates corresponding feature vectors. They conducted extensive experiments with 19 different 1DCNN architectures and, after determining the optimal model and parameters, input the extracted features into the best 1DCNN model for detection and classification. In the following embodiments, 1DCNN is used as baseline model.

### 7. STM-DT

Hou et al. introduced a network attack traffic classification model called Self-Training Mixed Decision Tree (STM-DT). The model employs frequency encoding to extract and normalize features of the traffic dataset, obtaining frequency representations. Subsequently, they construct the STM-DT model, which trains a decision tree using a small amount of labeled data and uses the model to predict unlabeled samples. The predicted samples are then mixed with labeled samples, and a new decision tree is trained on the mixed data to obtain the final classifier. In the following embodiments, 1DCNN is used d to detect botnet traffic as baseline model.

### System and FC-Bot

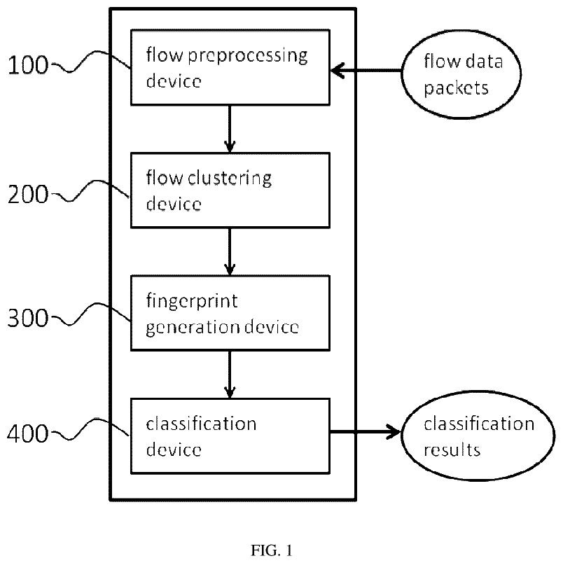

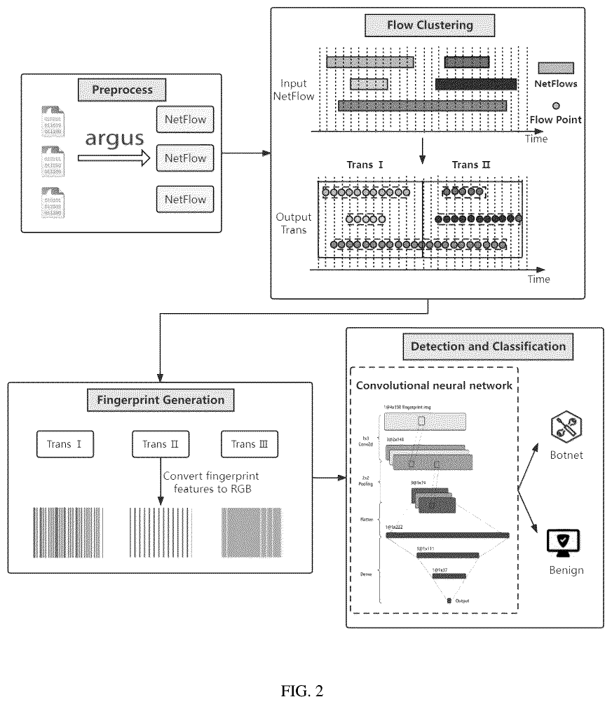

In the present disclosure, as shown in FIG. 1 the system for lightweight IoT Botnet detection based on flow point clustering comprises a flow preprocessing device 100, a flow clustering device 200, a fingerprint generation device 300 and a classification device 400. The system is configured to carry out the process a lightweight Internet of Things (IoT) botnet detection process called FC-Bot, based on flow point clustering. As shown in FIG. 2, the FC-Bot framework consists of four main components. 1) Flow preprocessing: Pcap data packets are processed using the Argus command to obtain NetFlow data. Zero-byte and zero-duration records are removed during this process. 2) Flow clustering: This is our core module. The NetFlow data is segmented and normalized to unify the temporal characteristics, resulting in flow points. Subsequently, multiple flow points are clustered using the HDBSCAN algorithm to form botnet transactions or normal behavior transactions. 3) Fingerprint generation: Feature fingerprints are extracted from the obtained transactions and converted into RGB fingerprint images. 4) Convolutional neural network (CNN) detection and classification: Finally, a CNN is employed to train and detect the fingerprint images, yielding the classification results.

### Preferred Embodiments

### 1. Dataset

### 1.1 Botnet Dataset

Three parts of botnet traffic are collected and compiled, including both publicly available datasets (IoT-23 and CIC-IDS2017), as well as a real-world dataset (the Antiy dataset).

The IoT-23 dataset consists of IoT traffic captured by CTU University in the Czech Republic from 2018 to 2019, covering 23 different IoT scenarios, including 20 malicious traffic and 3 normal traffic. After filtering, the malicious traffic related to botnet is selected, totaling 18.5 GB.

The CIC-IDS2017 dataset was captured by the Canadian Institute for Cybersecurity during the first week of July 2017. It contains benign traffic and the latest common attacks, such as web attacks, penetration testing, botnet, and DDoS attacks. The Friday traffic, which includes Botnet ARES traffic, is selected to complement the botnet traffic data, totaling 8.3 GB.

The Antiy dataset was captured from real-world open IoT environments using honeypots deployed worldwide by Antiy Company from October 2020 to December 2021. It includes botnet traffic captured from various IoT botnets, providing a broader coverage and more realistic data. The dataset amounts to 7.2 GB. It effectively complements the lack of botnet traffic.

It is important to note that the IoT-23 dataset and CIC-IDS2017 dataset contain benign traffic. After processing the data with Argus to obtain NetFlow data, it is necessary to filter out the botnet-related data. However, the Antiy dataset exclusively contains botnet-related traffic, so no additional filtering of the obtained Net-Flow is required.

### 1.2 Benign Dataset

The benign dataset consists of traffic collected from real-world IoT devices such as security systems, smart appliances, smart TVs, and wearable health devices, totaling approximately 170 GB.

### 1.3 Dataset Partition

The dataset is partitioned into training, validation, and testing sets. The botnet traffic is extracted from the IoT-23 dataset and CIC-IDS2017 dataset, supplemented by the botnet traffic from the Antiy dataset to compensate for the scarcity of malicious traffic. The partitioning was done in an 8:1:1 ratio for training, validation, and testing sets, respectively. Initially, only malicious traffic was present in the training, validation, and testing sets. To create a simulated environment, the sets are augmented with benign traffic collected and curated from real-world IoT devices. In the training and validation sets, the ratio of malicious to benign traffic was 1:3. Considering the limited availability of malicious traffic in real-world scenarios, the testing set contained 10% malicious traffic to provide a more realistic simulation.

After training the model using the training and validation sets, an additional period of Antiy real-world IoT traffic, which is captured from January to March 2022, is collected. This dataset encompassed predominantly benign traffic but also included in-stances of botnet attacks, penetration testing, and DDoS attacks directly captured from real-world environments, rendering it more authentic. This dataset was used as a direct test bed to evaluate the detection performance of the FC-Bot model in real-world scenarios. It is important to note that the objective of the present disclosure is to detect botnet; therefore, all non-botnet traffic in the dataset was labeled as benign.

### 2. Flow Preprocessing

A dataset of IoT botnet and benign traffic from real IoT devices is collected and organized. Then the collected data is processed to obtain NetFlow data. While it is possible to directly obtain data in the NetFlow format, it is generally preferred by universities and laboratories to provide data in the Pcap format. Therefore, an additional step of processing is needed. Argus is selected for this purpose, which is a network flow system that supports various flow technologies, including NetFlow, Jflow, Qflow, Kflow, and others. It efficiently and quickly processes packet data and generates summarized network flow data. Typically, processing 10 G of packet data takes less than 5 seconds.

After processing the data using Argus commands, the NetFlow data is obtained. Subsequently, zero-byte, zero-duration, and irrelevant protocol records (such as ICMP) are removed from the NetFlow data. Finally, the following fields that reflect the botnet are selected for the extraction of feature fingerprints and generation of fingerprint images in the subsequent steps.

| Field name | Description |
|---|---|
| StartTime | Flow sending time |
| Dur | Flow duration |
| Proto | Protocol used by the flow |
| SrcIP | Source IP address |
| DstIP | Destination IP address |
| Sport | Source port |
| Dport | Destination port |
| TotBytes | Number of bytes the flow contains |
| TotPkts | Number of packets the flow contains |

### 3. Transaction Generation Based on Flow Clustering

After completing the preprocessing of network flows, individual flow data alone is often insufficient to distinguish benign user behavior from IoT botnet behavior due to their collective nature. To address this issue, FC-Bot introduces the flow clustering module to detect the collective behavior of flows and differentiate their different behavioral patterns from the perspective of collective transactions.

The flow clustering module clusters all NetFlow records generated by the same transaction, allowing us to compare the differences between IoT botnet transactions and normal transactions. Here, transactions are defined as a series of actions performed by closely related botnet hosts or legitimate users. For example, a transaction can be a Xiaomi speaker querying a specific song and starting playback, or a group of bots launching a DDoS attack on the same target machine.

FC-Bot incorporates a flow clustering module to address the issue of unifying the start and end times of individual flows. Firstly, the flow is divided into multiple flow points to resolve the temporal alignment problem. Then, using the HDBSCAN algorithm, these flow points are clustered into different transactions. Each transaction consists of multiple flow points from different flows, representing a series of behavioral actions. By identifying these transactions, the detection of IoT botnet is achieved.

The implementation details are de-scribed as follows.

### 3.1 Flow Subset Partitioning

Given the initial flow dataset F, which contains all preprocessed NetFlow data f, we partition the dataset F into different subsets Fset based on the IP addresses of the flows f. Each subset represents the traffic sent or received by a specific source or destination IP address. For example, Fset with the same source IP address may represent the traffic of searching and playing a specific song on a Xiaomi speaker, while Fset with the same destination IP address may indicate the DDoS attacks launched by multiple bots targeting the same IP address. Therefore, different Fset may contain the same flow data.

### 3.2 Flow Point Segmentation

For each flow data within an Fset, its duration is divided into equally-sized time intervals based on a predefined segmentation time window Tw. A flow point p is defined for each time interval. Each flow point has four attributes: upstream and downstream bit rate (bits per second, bps) and up-stream and downstream packet rate (packets per second, pps).

### 3.3 Flow Point Space Transformation

The mutual reachability distance d_{mreach-k} between two flow points is defined as shown in Equation (1), where d represents the Euclidean distance and corek(p) denotes the distance between flow point p and the k-th nearest neighbor sample point, which is known as the core distance. The calculation formula for the core distance is shown in Equation (2).

$${d}_{mreach - k} ( {p}_{1} , {p}_{2} ) = max \{ {core}_{k} ( {p}_{1} ) , {core}_{k} ( {p}_{2} ) , d ( {p}_{1} , {p}_{2} ) \} \qquad ( 1 )$$

$${core}_{k} ( p ) = d ( p , {N}^{k} ( p ) ) \qquad ( 2 )$$

The mutual reachability distance represents the maximum value between the core distance of flow points p1 and p2 and the distance between the two sample points. By using the mutual reachability distance to measure the distance between flow points, a transformation of the flow point space is achieved. This transformation ensures that the distance between sample points in dense regions is unaffected, while the distance between sample points in sparse regions and other sample points is amplified. As a result, the clustering algorithm exhibits better robustness in non-dense regions.

### 3.4 Constructing the Minimum Spanning Tree

To achieve clustering, i.e., the partitioning of transactions, in the dense dataset formed by flow points, the mutual reachability distance obtained in the previous step is used as the distance measure for flow points. Since the definition of dense regions is relative, and different clusters have different flow point densities, the dense dataset formed by flow points is regarded as a weighted graph. In this graph, flow points serve as vertices, and the weight of any edge between two flow points is their mutual reachability distance, d_{mreach-k}(p1, p2). Then, regarding a threshold γ, start with a relatively high value and gradually decrease γ, removing all edges with weights exceeding γ to achieve graph splitting. Throughout the process, the graph transitions from being fully connected to completely disconnected. The resulting split of the graph can be understood as partitioning the weighted graph using the current threshold γ to obtain clusters.

However, the time complexity of the aforementioned operations is O(n²). To reduce complexity, the minimum spanning tree algorithm from graph theory is used to implement the above process. Specifically, the Prim's algorithm is used to construct the minimum spanning tree of the mutual reachability distances. This algorithm iteratively selects the edge with the lowest weight from the edges connecting the current tree nodes with the external nodes and adds it to the tree. Deleting any edge in the minimum spanning tree results in the tree being split into two subtrees, and it is not possible to find a lower-weight edge to connect the disconnected subtrees.

### 3.5 Clustering Binary Tree and Pruning

All the edges in the minimum spanning tree are sorted in ascending order and each edge is selected one by one. The two subtrees connected by the selected edge are merged, resulting in a clustering binary tree. In this binary tree, each node represents a cluster of flow points, and the top-level root node rep-resents the entire set of flow points. Each node in the binary tree has two edges, which represent the split of the current subtree. The highest-weighted edge in the current minimum spanning tree is removed to further split the tree into two subtrees. Each split corresponds to a distance, which is the weight of the removed edge.

Next, pruning compression is performed on the clustering binary tree to remove outliers and ensure that each node in the clustering tree represents a cluster of appropriate size. The minimum cluster size is defined as Minsize and traverse the clustering tree from top to bottom. If both child nodes of a node have a number of flow points greater than Minsize, it is regarded as a splittable cluster and continue traversing down from these two child nodes while preserving the parent node before the split. This parent node contains all the flow points from the two child nodes. If only one child node has a number of flow points greater than Minsize, the current parent node is replaced with that child node and continue traversing down. If both child nodes have a number of flow points smaller than Minsize, these two child nodes are removed.

### 3.6 Extraction of Clustering Results

By performing compression operations on the tree structure, sparse nodes within the tree are effectively eliminated. The next step is to further merge the most similar nodes, known as flow point clusters, in order to obtain the final clustering results. To achieve this, we introduce the reciprocal of distance as a parameter, de-noted as λ. For each flow point p, λₚ represents the reciprocal of the length of the corresponding severed edge when p is separated from the flow point cluster. Additionally, λ_{birth} is defined to represent the reciprocal of the length of the severed edge during the current node's splitting, which characterizes the closeness between the current flow point cluster and its sibling cluster. A higher value of λ_{birth} indicates greater stability within the cluster, meaning fewer outliers exist within the cluster. Based on these definitions, the stability formula for each subset is formulated as shown in Equation (3), where a higher stability value indicates fewer outliers within the cluster.

$${s}_{cluster} = {\sum }_{p ∈ cluster} ( {λ}_{p} - {λ}_{birth} ) \qquad ( 3 )$$

The final step is to identify the clustering results by finding the maximum stability. Start by initializing clusters, considering each leaf node as an initial cluster. Then, traverse the entire tree in a bottom-up manner. If the stability of the current node is smaller than the sum of the stabilities of its two child nodes, update the stability of the current node to be the sum of its child nodes' stabilities. If the stability of the current node is greater than the sum of its two child nodes' stabilities, treat the current node as a cluster and delete all its child nodes. In the end, the clusters are obtained, where each cluster represents a transaction.

Through the flow clustering module, NetFlow data is transformed into distinct transactions, enabling them to be analyzed at the collective behavioral level. This facilitates the differentiation between normal transactions and botnet transactions.

### 4. Transaction Fingerprint Generation

Once transactions are obtained from the flow clustering module, each transaction may contain a varying number of NetFlow flow records with inconsistent information. In order to enable direct comparison be-tween different transactions, it is necessary to define, extract, and normalize features from the clustered flows of each transaction.

FC-Bot generates a feature fingerprint for each transaction by designing a data fusion method that de-rives an f×N matrix from the transaction, which serves as the transaction's fingerprint. Here, N refers to the number of time slots contained within the transaction's time window. The time window represents the duration spanning from the earliest starting time to the latest ending time among all flows included in the transaction. f represents the number of extracted transaction features.

Due to the segmentation of flows into flow points and the clustering of flow points into transactions, clustered transactions may include flow points from different flows, and a flow point from a single flow may also belong to different transactions. As a result, traditional packet-level features (such as average time of forward packets) and flow-level features (longest active duration of flows) are no longer applicable. The extracted 4×N transaction feature fingerprint matrix includes four categories of features: uplink (bytes per second—bps and packets per second—pps) and downlink (bps and pps). Each transaction represents data sent or received by a source IP or destination IP. Therefore, the uplink corresponds to the sender, while the downlink corresponds to the receiver. Additionally, since multiple flow records can exist within any time slot of a transaction, the bps and pps values for that time slot should be the sum of the bps and pps values of all flow points within that time slot.

Once the transaction feature fingerprint matrix is generated, it needs to be normalized. We use the tanh activation function to map each value in the matrix to a number between 0 and 255. However, it was found that the bps and pps values of each transaction tend to be very large in practice, often in the order of tens of thousands for the former and thousands for the latter. When using the conventional tanh function for processing, the resulting distribution is highly concentrated, with a majority of values above 0.9, which fails to reflect the differentiation among transactions. Therefore, as shown in Formula (4), the tanh function is modified to tanh′ function by adding a power parameter ω to correct the influence of excessively large input parameter x. After being processed by the tanh′ function, the data is mapped to the [0, 1] interval and then multiplied by 255 to obtain the normalized result.

$${tanh}^{′} x = \frac{{e}^{ω x} - {e}^{- ω x}}{{e}^{ω x} + {e}^{- ω x}} \qquad ( 4 )$$

$${x}_{o u t} = 255 \times {tanh}^{′} x$$

When the input parameter x is relatively small, ω is increased; conversely, when x is relatively large, ω is decreased. This means that the influence of x is enhanced when it is small on the normalized result and reduce the influence of x when it is large. Specifically, after studying the value distributions of bps and pps in real-world IoT traffic (170 G dataset) and botnet dataset, ω is selected as 0.000001 for bps values and 0.001 for pps values.

Now, each data point in the fingerprint matrix falls within the range of 0 to 255. Next, the up-stream and downstream traffic are processed separately. For a transaction matrix with a duration of N, its length is set as N pixels. For pixel I (I=1, . . . , N), its RGB value is represented as (R, G, B)=(bps, pps, 0), and the remaining blank pixels are filled with (255, 255, 255). This mapping allows smaller bps or pps values to be represented by darker colors. This process generates fingerprint images of upstream and downstream traffic, both having dimensions of 2×N pixels, where each column has the same RGB values.

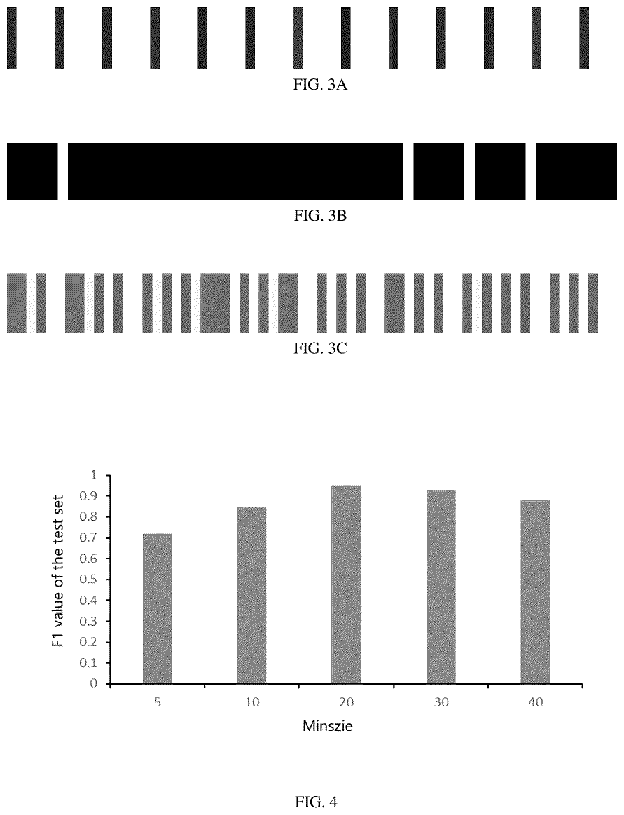

FIG. 3 illustrates examples of three fingerprint images. FIG. 3(a) shows the fingerprint image of the upstream traffic from an infected bot regularly contacting a botnet C&C server, possibly uploading bot status reports. FIG. 3(b) represents the traffic image generated by multiple bots launching DDoS attacks against a target IP. Most of the images from botnets fall into this category. FIG. 3(c) displays the fingerprint image of downstream traffic originating from IoT devices accessing a specific domain. It exhibits clearer continuity and lacks a specific pattern in its distribution. From these images, different patterns are clearly show in color depth, frequency, regularity, and density be-tween transaction fingerprints of IoT botnets and those of genuine users.

### 5. Convolutional Neural Network Model

In recent years, with the rapid development of machine learning and deep learning, an increasing number of studies have started utilizing artificial intelligence techniques for detecting IoT botnet. Alkahtani et al. proposed a detection method based on the CNN-LSTM model, successfully detecting botnet in nine commercial IoT devices with an average accuracy exceeding 88%. Aydin et al. presented an online network intrusion detection system based on convolutional neural networks (CNN), capable of rapidly and accurately detecting DDoS traffic generated by IoT botnet.

The architecture of convolutional neural networks (CNN) using Keras and TensorFlow is implemented here. The architecture of the CNN is as follows. The input is the obtained 4×N fingerprint image, which goes through a 3×3 convolutional layer, a 2×2 pooling layer, and a flattening layer to obtain a one-dimensional vector. Subsequently, it passes through several hidden layers to obtain the classification results. Each hidden layer is followed by a Dropout layer with a dropout rate of 0.5, which helps prevent overfitting. ReLU is used as the activation function for the hidden layers to facilitate fast convergence of the model. The output layer uses the Softmax function to produce binary classification results. Additionally, the CNN model is trained using the stochastic gradient descent optimization algorithm and updated using the backpropagation algorithm.

### 6. Results

### 6.1 Baseline Model Selection

To thoroughly evaluate the performance of FC-Bot, four state-of-the-art flow-based botnet detection methods are selected for comparison, including Kitsune, Whisper, 1DCNN and STM-DT. To ensure a fair comparison, all methods were fine-tuned to achieve high accuracy on the evaluation dataset.

### 6.2 Metrics Selection

The metrics shown in Table 1 are adopted. True Positive (TP) represents the normal traffic correctly identified as normal, True Negative (TN) represents the malicious traffic correctly identified as malicious, False Positive (FP) represents the malicious traffic incorrectly identified as normal, and False Negative (FN) represents the normal traffic incorrectly identified as malicious.

TABLE 1
Evaluation Metrics

| Metrics | Equation |
|---|---|
| Precision | $\frac{T P}{T P + F P}$ |
| Recall | $\frac{T P}{T P + FN}$ |
| F1 | $\frac{2 \times precision \times recall}{precision + recall}$ |
| FPR | $\frac{F P}{F P + T N}$ |

Accuracy reflects the correct classification of positive and negative instances, but it may not accurately represent the model's performance when there is class imbalance. Precision, recall, and F1 score, on the other hand, can still provide insights into the model's effectiveness even in situations with a significant difference in the number of positive and negative instances. Therefore, accuracy is not considered as an evaluation metric.

### 6.3 Configuration and Analysis of FC-Bot System Parameters

### 6.3.1 Default Values of System Parameter

1) For flow point segmentation, the length of each segment (Tw) is defined as 1 second. This setting is based on that botnet C&C servers and infected bots often contact or receive commands at regular intervals. A smaller time interval would result in longer fingerprint matrices and more complex calculations. However, this parameter can be adjusted since a smaller time interval can yield more accurate results at a higher computational cost. For flows with durations less than 1 second, round their start and end times and choose the nearest integer time representation for the flow point.

2) For the traffic clustering module, select the minimum cluster size (Minsize). According to the user behavior model from a network perspective, users usually do not trigger NetFlow records within 10 to 20 seconds. Additionally, the time interval between frequent contacts of C&C servers and bots is often less than 20 seconds. Therefore, the transaction time interval is generally within 10 to 20 seconds, which translates to a minimum cluster size of no fewer than 20 flow points. Minsize is set to 20. If Minsize is too small, some outliers may be wrongly identified as transactions. If Minsize is too large, some small trans-actions may be mistakenly classified as outliers.

3) For the transaction fingerprint generation module, N is set to 150, which is the pixel value representing the length of the fingerprint image. This setting is based on that the duration of frequent contacts between C&C servers and bots rarely exceeds 150 seconds. A larger value of N will produce more accurate results, but it requires more training data and computational resources.

### 6.3.2 Discussion on the Minimum Cluster Size (Minsize)

A study is conducted on the minimum cluster size (Minsize), which affects the F1 score of the model on the test set. Minsize values of 5, 10, 20, 30, and 40 are selected for the flow clustering module. The models were trained on the training set, and the test set was used to evaluate the model's performance. FIG. 4 illustrates the F1 scores on the test set for different Minsize values.

From the graph, it can be observed that the F1 score initially increases and then decreases as Minsize increases. When Minsize is set to 20, the convolutional neural network achieves the highest F1 score of 0.95 on the test set. However, as Minsize continues to increase, the F1 score gradually decreases.

When Minsize is too small, some benign short flows are incorrectly clustered as transactions. These short and fast flows exhibit similarities to DDoS attack flows, leading to misclassifications and a decrease in the F1 score. On the other hand, when Minsize is too large, some control flows of botnets are misidentified as outliers, resulting in the omission of some botnet transactions and a decrease in the F1 score. Based on these findings, Minsize is selected as 20 for the model ultimately.

### 6.3.3 Discussion on the Duration N

According to the botnet dataset, the most common DDoS traffic in botnet is often tightly connected and exhibits distinct features, with less dependence on the value of N. However, for botnet control traffic, it relies more on the appropriate selection of N. This is because the duration of communication be-tween C&C servers and botnet hosts in botnet rarely exceeds 150 seconds, but there are also cases where it exceeds 200 seconds, as well as some durations less than 50 seconds. Therefore, it is necessary to further discuss the duration N in the fingerprint generation module, which is also the pixel value of the image length.

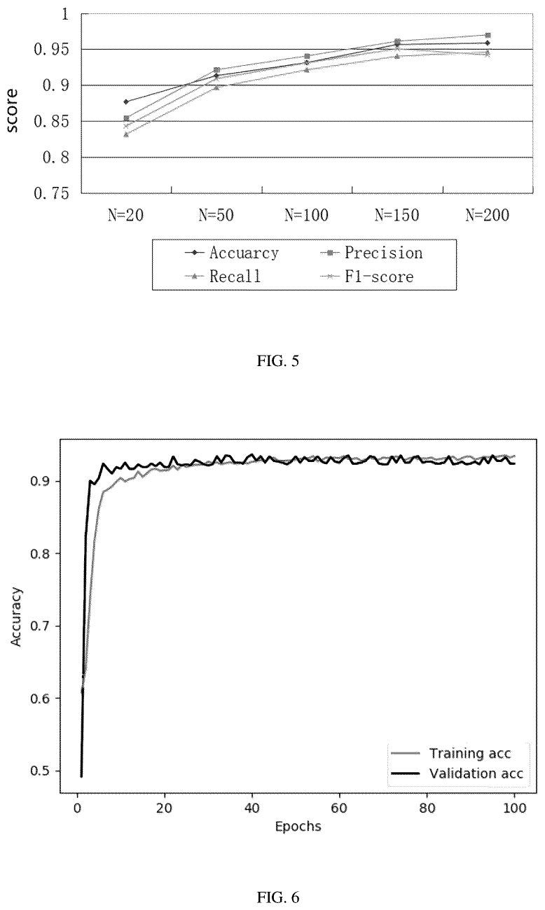

As shown in FIG. 5, experiments are conducted for different N values. From the results, it can be observed that as the value of N increases, the model's performance metrics also improve, which aligns with our expectations. Further analysis reveals a significant in-crease when N increases from 20 to 50. This is because for botnet control traffic, the majority of C&C server communication with botnet hosts lasts longer than 50 seconds. If N is set to 20, it may incorrectly divide some transactions into two parts, resulting in errors. When N exceeds 150, the growth rate becomes slower. This is because only a very small portion of botnet control traffic has a communication duration exceeding 150 seconds. Although larger N values are more advantageous for accurately representing complete trans-actions, they also increase the computational burden of the model. Taking these factors into consideration, N is selected as 150 ultimately.

### 6.4 Detection Results of FC-Bot With Optimal Parameters

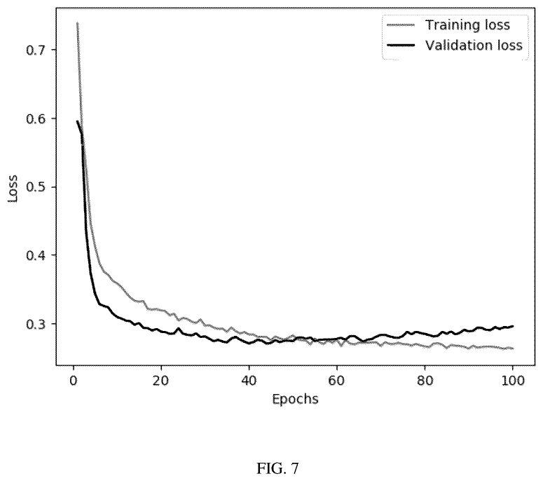

When using the above optimal parameters, the accuracy curve and loss curve of FC-Bot on the training and validation sets are shown in FIG. 6 and FIG. 7, respectively. Additionally, the performance metrics on the test set are presented in Table 2. It can be observed that when using the optimal parameters, FC-Bot achieves a precision of 96.11%, a recall of 94.00%, and an F1 score of 95.04% on the test set. This indicates that the model can identify and correctly classify the majority of botnet traffic, demonstrating good performance.

TABLE 2
Results of FC-Bot on the test set
when using optimal parameter values

| Precision | Recall | F1 | FPR |
|---|---|---|---|
| 96.11% | 94.00% | 95.04% | 3.06% |

### 6.5 Comparison With Existing State-of-the-Art Models

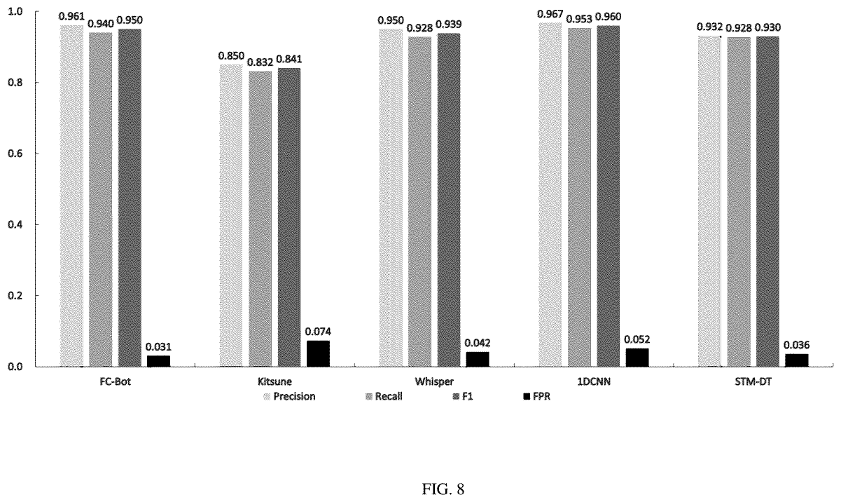

The experimental results comparing the present disclosure with the four detection methods including Kitsune, Whisper, 1DCNN, and STM-DT are shown in Table 3 and FIG. 8.

TABLE 3
Comparison of experimental results
between FC-Bot and advanced models

| Method | Precision | Recall | F1 | FPR |
|---|---|---|---|---|
| FC-Bot | 96.11% | 94.00% | 95.04% | 3.06% |
| Kitsune | 84.98% | 83.15% | 84.06% | 7.36% |
| Whisper | 94.96% | 92.79% | 93.86% | 4.17% |
| 1DCNN | 96.74% | 95.32% | 96.02% | 5.15% |
| STM-DT | 93.16% | 92.78% | 92.97% | 3.58% |

It can be observed that the 1DCNN model achieves the highest precision and recall, at 96.74% and 95.32%, respectively, but it has a higher false positive rate of 5.15%. FC-Bot achieves the second-best results in terms of precision, recall, and F1 score, slightly lower than 1DCNN but with a smaller margin, and it has a significant advantage in terms of false positive rate.

In the experimental comparison, Kitsune, which analyzes packets at the packet level, achieves relatively poorer results with lower precision and recall. The analysis reveals that Kitsune overlooks the flow-level information of botnets, and its anomaly detection based solely on packet features fails to detect certain malicious traffic disguised as benign traffic.

Whisper proposes a frequency domain-based approach, representing traffic sequence information using frequency domain features, and achieves good results. However, it is fundamentally based on anomaly detection, and the limitation lies in the benign cluster centers obtained from a benign traffic dataset, leading to mis-classification of some benign traffic as botnet traffic due to outliers in our dataset.

STM-DT can detect different types of network at-tack traffic from clustered network flow data, not limited to botnet detection alone. All traffic is labeled except botnet traffic as benign, while STM-DT further distinguishes traffic beyond botnets, such as distinguishing XSS injection attacks, brute force attacks, etc. This leads to a decrease in precision and recall. Additionally, STM-DT only extracts 38 features from the botnet dataset, which may result in a decrease in precision due to incomplete feature extraction.

FC-Bot achieves relatively good results with precision and recall of 96.11% and 94.00%, respectively, close to the 1DCNN model, and it achieves the lowest FPR of 3.06%.

Furthermore, the present inventor also found that FC-Bot has the highest AUC value, improving by 5% compared to other methods, further demonstrating the effectiveness of the approach.

In summary, FC-Bot introduces the flow clustering module into botnet detection, effectively addressing the temporal uniformity issue and achieving collective-level behavior by segmenting and clustering flows. It detects botnet from a transactional perspective and achieves good results. Compared to Kitsune, which extracts packet-level features, FC-Bot can better extract flow-level information of botnets to improve detection accuracy. Whisper, a frequency domain analysis method, relies heavily on obtaining benign traffic cluster centers and classifying outliers as malicious traffic, which poses limitations that FC-Bot does not have to worry about. Additionally, the STM-DT method relies on prior knowledge to extract features and lacks effective observation of shared features of botnet. The 1DCNN model focuses on the temporal and contextual features of botnet but overlooks the high-dimensional transactional features, and cannot detect from a collective behavior perspective, resulting in a higher false positive rate.

### REFERENCES

1. Yan Z, Niemi V, Yang L T. Key technologies for 5G, the next generation of mobile networks and services[J]. International Journal of Communication Systems, 2016, 29(16): 2328-2329.

2. GSMA. The Internet of Things by 2025. https://www.gsma.com/iot/wp-content/uploads/2018/08/GSMA-IoT-Infographic-2019.pdf. August 2018.

3. Straits Research. IT Security Market. https://straitsresearch.com/report/iot-security-market/segmentation. February 2023.

4. Fortinet. 2022 Global Threat Landscape Report. https://global.fortinet.com/lp-en-ap-2022globalthreatlandscape-H2. August 2022.

5. Vinayakumar R, Alazab M, Srinivasan S, et al. A visualized botnet detection system based deep learning for the internet of things networks of smart cities[J]. IEEE Transactions on Industry Applications, 2020, 56(4): 4436-4456.

6. Gao H, Hu J, Wilson C, et al. Detecting and characterizing social spam campaigns[C]. Proceedings of the 10th ACM SIGCOMM conference on Internet measurement.2010:35-47.

7. Doshi R, Apthorpe N, Feamster N. Machine learning ddos detection for consumer internet of things devices[C]. 2018 IEEE Security and Privacy Workshops (SPW), 2018: 29-35.

8. Hussain F, Abbas S G, Fayyaz U U, et al. Towards a universal features set for IoT botnet attacks detection[C]. 2020 IEEE 23rd International Multitopic Conference (INMIC), 2020: 1-6.

9. Wazzan M, Algazzawi D, Bamasaq O, et al. Internet of Things botnet detection approaches: Analysis and recommendations for future research[J]. Applied Sciences, 2021, 11(12): 5713.

10. Al Shorman A, Faris H, Aljarah I. Unsupervised intelligent system based on one class support vector machine and Grey Wolf optimization for IoT botnet detection[J]. Journal of Ambient Intelligence and Humanized Computing, 2020, 11: 2809-2825.

11. Soe Y N, Feng Y, Santosa P I, et al. Machine learning-based IoT-botnet attack detection with sequential architecture[J]. Sensors, 2020, 20(16): 4372.

12. Sriram S, Vinayakumar R, Alazab M, et al. Network flow based IoT botnet attack detection using deep learning[C]. IEEE INFOCOM 2020-IEEE conference on computer communications workshops (INFOCOM WKSHPS), 2020: 189-194.

13. Hussain F, Abbas S G, Pires I M, et al. A two-fold machine learning approach to prevent and detect IoT botnet attacks[J]. IEEE Access, 2021, 9: 163412-163430.

14. Gandhi H, Mehra M, Ribeiro V. Bond: Efficient and frugal d1 model co-design for botnet detection on iot gateways[C]. The First International Conference on AI-ML-Systems, 2021: 1-7.

15. Alzahrani H, Abulkhair M, Alkayal E. A multi-class neural network model for rapid detection of IoT botnet attacks[J]. Int. J. Adv. Comp. Sci. Appl, 2020, 11(7): 688-696.

16. Bojarajulu B, Tanwar S, Singh T P. Intelligent IoT-BOTNET attack detection model with optimized hybrid classification model[J]. Computers & Security, 2023, 126: 103064.

17. Bilge L, Balzarotti D, Robertson W, et al. Disclosure: detecting botnet command and control servers through large-scale netflow analysis[C]. Proceedings of the 28th Annual Computer Security Applications Conference. 2012: 129-138.

18. B. Claise. Cisco systems netflow services export version 9. Technical report No. rfc3954, 2004.

19. Singh D, Tripathi G, Jara A J. A survey of Internet-of-Things: Future vision, architecture, challenges and services[C]. 2014 IEEE world forum on Internet of Things (WF-IoT), 2014: 287-292.

20. McInnes L, Healy J, Astels S. hdbscan: Hierarchical density based clustering[J]. J. Open Source Softw., 2017, 2(11): 205.

21. Asyaky M S, Mandala R. Improving the performance of HDBSCAN on short text clustering by using word embedding and UMAP[C]. 2021 8th International Conference on Advanced Informatics: Concepts, Theory and Applications (ICAICTA), 2021: 1-6.

22. Alkahtani H, Aldhyani T H H. Botnet Attack Detection by Using CNN-LSTM Model for Internet of Things Applications[J]. Security and Communication Networks, 2021, 2021.

23. Aydin E, Bahtiyar Ş. OCIDS: An Online CNN-Based Network Intrusion Detection System for DDoS Attacks with IoT Bot-nets[C]. 2021 14th International Conference on Security of Information and Networks (SIN), 2021: 1-8.

24. Stratosphere Laboratory. IoT-23: A labeled dataset with malicious and benign IoT network traffic. https://www.stratosphereips.org/datasets-iot23. March, 2020.

25. Sharafaldin I, Lashkari A H, Ghorbani A A. Toward generating a new intrusion detection dataset and intrusion traffic characterization[J]. International Conference on Information Systems Security and Privacy (ICISSP), 2018, 1: 108-116.

26. Mirsky Y, Doitshman T, Elovici Y, et al. Kitsune: An Ensemble of Autoencoders for Online Network Intrusion Detection[EB/OL]. 2018: ArXiv Preprint ArXiv: 1802.09089.

27. Fu C, Li Q, Shen M, et al. Realtime robust malicious traffic detection via frequency domain analysis[C]. Proceedings of the 2021 ACM SIGSAC Conference on Computer and Communications Se-curity. 2021: 3431-3446.

28. Kundu P P, Truong-Huu T, Chen L, et al. Detection and classification of botnet traffic using deep learning with model explanation[J]. IEEE Transactions on Dependable and Secure Computing(TDSC), 2022.

29. Hou Y, Teo S G, Chen Z, et al. Handling Labeled Data Insufficiency: Semi-supervised Learning with Self-Training Mixup Decision Tree for Classification of Network Attacking Traffic[J]. IEEE Transactions on Dependable and Secure Computing(TDSC), 2022.

30. Schneider F, Feldmann A, Krishnamurthy B, et al. Understanding online social network usage from a network perspective[C]. Proceedings of the 9th ACM SIGCOMM Conference on Internet Measurement, 2009: 35-48.

31. VirusTotal. VIRUSTOTAL. https://www.virustotal.com/. June. 2004.

32. CVE. CVE-2021-44228. http://cve.mitre.org/cgi-bin/cvename.cgi?name=CVE-2021-44228. November 2021.

33. Wang C Y, Ou CL, Zhang Y E, et al. BotCluster: a session-based P2P botnet clustering system on NetFlow[J]. Computer Networks, 2018, 145: 175-189.

34. Özçelik M, Chalabianloo N, Gür G. Software-defined edge defense against IoT-based DDoS[C]. 2017 IEEE international conference on computer and information technology (CIT), 2017: 308-313

35. Summerville D H, Zach K M, Chen Y. Ultra-lightweight deep packet anomaly detection for Internet of Things devices[C]. 2015 IEEE 34th international performance computing and communications conference (IPCCC), 2015: 1-8.

36. Kolias C, Kambourakis G, Stavrou A, et al. DDoS in the IoT: Mirai and other botnets[J]. Computer, 2017, 50(7): 80-84.

37. Dange S, Chatterjee M. IoT botnet: The largest threat to the IoT network[M]. Singapore: Springer Singapore, 2019: 137-157.

38. Gu G, Porras P A, Yegneswaran V, et al. Bothunter: Detecting malware infection through ids-driven dialog correlation[C]. USENIX Security Symposium. 2007, 7: 1-16.

39. Babu ES, Rao M S, Pemula R, et al. A Hybrid Intrusion Detection System against Botnet Attack in IoT using Light Weight Signature and Ensemble Learning Technique[J]. Research Square, 2022.

40. Singh M, Singh M, Kaur S. Issues and challenges in DNS based botnet detection: A survey[J]. Computers & Security, 2019, 86: 28-52.

41. Xing Y, Shu H, Zhao H, et al. Survey on botnet detection techniques: classification, methods, and evaluation[J]. Mathematical Problems in Engineering, 2021, 2021: 1-24.

42. Lashkari A H, Gil G D, Keenan J E, et al. A survey leading to a new evaluation framework for network-based botnet detection[C]. Proceedings of the 2017 the 7th International Conference on Communication and Network Security, 2017: 59-66.

43. Koroniotis N, Moustafa N, Sitnikova E, et al. Towards the development of realistic botnet dataset in the internet of things for net-work forensic analytics: Bot-iot dataset[J]. Future Generation Computer Systems, 2019, 100: 779-796.

44. Azab A, Alazab M, Aiash M. Machine learning based botnet identification traffic[C]. 2016 IEEE Trustcom/BigDataSE/ISPA, 2016: 1788-1794.

45. Li L, Ota K, Zhang Z, et al. Security and privacy protection of social networks in big data era[J]. Mathematical Problems in Engineering, 2018, 2018.

46. Nguyen G L, Dumba B, Ngo Q D, et al. A collaborative approach to early detection of IoT Botnet[J]. Computers & Electrical Engineering, 2022, 97: 107525.

47. Alani M M. BotStop: Packet-based efficient and explainable IoT botnet detection using machine learning[J]. Computer Communications, 2022, 193: 53-62.

48. Wei C, Xie G, Diao Z. A Lightweight Deep Learning Framework for Botnet Detecting at the IoT Edge[J]. Computers & Security, 2023: 103195.

49. Chen S C, Chen Y R, Tzeng W G. Effective botnet detection through neural networkson convolutional features[C]. 2018 17th IEEE International Conference On Trust, Security And Privacy In Computing And Communications/12th IEEE International Conference On Big Data Science And Engineering (Trust-Com/BigDataSE), 2018: 372-378.

50. Sadique F, Sengupta S. Modeling and analyzing attacker behavior in IoT botnet using temporal convolution network (TCN)[J]. Computers & Security, 2022, 117: 102714.

51. Meidan Y, Bohadana M, Mathov Y, et al. N-baiot-network-based detection of iot botnet attacks using deep autoencoders[J]. IEEE Pervasive Computing, 2018, 17(3): 12-22.

52. Bertino E, Islam N. Botnets and internet of things security[J]. Computer, 2017, 50(2): 76-79.

53. Rahmantyo D T, Erfianto B, Satrya G B. Deep residual cnn for preventing botnet attacks on the internet of things[C]. 2021 4th International Conference of Computer and Informatics Engineering (IC2IE), 2021: 462-466.

54. Joshi C, Ranjan R K, Bharti V. A Fuzzy Logic based feature engineering approach for Botnet detection using ANN[J]. Journal of King Saud University-Computer and Information Sciences, 2022, 34(9): 6872-6882.

55. Popoola S I, Ande R, Adebisi B, et al. Federated deep learning for zero-day botnet attack detection in IoT-edge devices[J]. IEEE Internet of Things Journal, 2021, 9(5): 3930-3944.

56. Nguyen H T, Ngo Q D, Le V H. A novel graph-based approach for IoT botnet detection[J]. International Journal of Information Security, 2020, 19(5): 567-577.

57. Nguyen T N, Ngo Q D, Nguyen H T, et al. An advanced computing approach for IoT-botnet detection in industrial Internet of Things[J]. IEEE Transactions on Industrial Informatics, 2022, 18(11): 8298-8306.

1. A system for lightweight IoT Botnet detection based on flow point clustering, comprising:
a flow preprocessing device for processing the flow data packets to obtain NetFlow data;
a flow clustering device for segmenting the NetFlow data to obtain flow points, and clustering the flow points to form botnet transactions or normal behavior transactions;
a fingerprint generation device for extracting feature fingerprints from the obtained transactions and converting the feature fingerprints into RGB fingerprint images; and
a classification device for detecting the fingerprint images and yielding the classification results.

2. The system of claim 1, wherein the flow data packets comprise Pcap data packets.

3. The system of claim 1, wherein the flow preprocessing device is configured to use the Argus command to obtain the NetFlow data.

4. The system of claim 1, wherein the flow preprocessing device is configured to remove zero-byte and zero-duration records in the process of obtaining the NetFlow data.

5. The system of claim 1, wherein the flow preprocessing device is configured to use the following fields for the flow clustering unit:

| Field name | Description |
|---|---|
| StartTime | Flow sending time |
| Dur | Flow duration |
| Proto | Protocol used by the flow |
| SrcIP | Source IP address |
| DstIP | Destination IP address |
| Sport | Source port |
| Dport | Destination port |
| TotBytes | Number of bytes the flow contains |
| TotPkts | Number of packets the flow contains. |

6. The system of claim 1, wherein flow clustering device is configured to divide duration of NetFlow data into equally-sized time intervals based on a predefined segmentation time window, and define a flow point for each time interval, to segment the NetFlow data to obtain flow points.

7. The system of claim 6, wherein each flow point has four attributes including upstream and downstream bit rate, and up-stream and downstream packet rate.

8. The system of claim 1, wherein flow clustering device is configured to use the HDBSCAN algorithm to cluster the flow points to form botnet transactions or normal behavior transactions.

9. The system of claim 1, wherein fingerprint generation device is configured to generate a feature fingerprint for each transaction by designing a data fusion method that derives an f×N matrix from the transaction, which serves as the transaction's fingerprint, wherein N refers to the number of time slots contained within the transaction's time window, and f represents the number of extracted transaction features.

10. The system of claim 1, wherein the classification device is configured to use a convolutional neural network to train and detect the fingerprint images.

11. The system of claim 1, wherein the convolutional neural network has an architecture as follows:
the input is the obtained 4×N fingerprint image, which goes through a 3×3 convolutional layer, a 2×2 pooling layer, and a flattening layer to obtain a one-dimensional vector;
it passes through several hidden layers to obtain the classification results, and each hidden layer is followed by a Dropout layer with a dropout rate of 0.5, which helps prevent overfitting;
ReLU is used as the activation function for the hidden layers to facilitate fast convergence of the model; and
the output layer uses the Softmax function to produce binary classification results.

12. The system of claim 1, wherein the convolutional neural network is trained using the stochastic gradient descent optimization algorithm and updated using the backpropagation algorithm.
